(19) United States
(12) Patent Application Publication
(10) Pub. No.: US 2006/0007359 A1
(43) Pub. Date: Jan. 12, 2006

(54) Method and system for switching between video modes in consumer electronics

(76) Inventor: Phanthavong Douangphachanh, San Jose, CA (US)

Correspondence Address: ROBERT PLATT BELL, P.O. BOX 310, AURORA, NY, 13026, US

(21) Appl. No.: 10/926,060

(22) Filed: Aug. 26, 2004

Related U.S. Application Data
(60) Provisional application No. 60/585,072, filed on Jul. 6, 2004.

(51) Int. Cl. H04N 3/27

(52) U.S. Cl. 348/554; 348/556

(57) ABSTRACT

DVD players and the like may support multiple video formats, including interlaced and progressive scan video. If a user selects a mode (e.g., progressive scan) not supported by their monitor or television, then the user may lose the video image output, and can no longer see the GUI (Graphical User Interface) which would allow the user to switch back to the previous mode. The present invention solves this problem by providing a method and system whereby a new display mode or resolution is generated and a message displayed requesting the user to confirm whether the resultant display is acceptable. If the user does not respond to the message after a predetermined period of time (e.g., 20 seconds), then the system reverts back to the previous resolution or mode. The system thus prevents and corrects for the cases where a user selects an inappropriate video output. In addition, a user-friendly interface, which results in better customer satisfaction, is provided. Moreover, while minor software changes to the operating system of the consumer electronic video device (e.g., DVD player) may be required, the need for new hardware is eliminated.

### CROSS-REFERENCE TO RELATED APPLICATIONS

The present application claims priority from Provisional U.S. Patent Application No. 60/585,072, filed on Jul. 6, 2004, and incorporated herein by reference.

### FIELD OF THE INVENTION

The present invention relates to DVD players and recorders and other consumer video electronics. In particular, the present invention is directed toward a method and apparatus for switching between different video output modes in a consumer video electronic device.

### BACKGROUND OF THE INVENTION

In the Prior Art, consumer electronic video devices were generally provided with a limited number of output modes. For example, a typical VCR may have been provided with a 75 Ohm coaxial cable connection which would provide NTSC video modulated on a selectable channel (e.g., channel 3 or 4). With the advent of more sophisticated consumer television monitors, other outputs are being provided, including composite video as well as S-video connectors. For most of these consumer video devices, output signals are driven to all output ports such that the consumer will always see a television image no matter which port they select to connect their television.

In the Prior Art, most consumer electronic devices were manufactured with specific markets in mind. Specifically, for North America, devices may be configured to generate NTSC video outputs, whereas for some foreign markets, PAL (Phase Alternating Line) or SECAM (Sequential Couleur Avec Memoire or Sequential Color with Memory) output signals may be used. Since most consumers typically did not move from one locale to another locale, manufacturing a consumer electronic video device capable of multiple output formats was not considered necessary or economical. However, with increased mobility, consumers moving to areas where different television signal formats are used has become more common. Moreover, being able to generate outputs in multiple formats may provide for a more desirable product and also reduce the need for different product models for different markets.

In addition to these concerns, many consumer electronic video devices (e.g., DVD players and the like) may support multiple video formats, as noted above, including composite video, S-video, component video, as well as interlaced and progressive scan video. Some of these multiple formats may use common output plugs or may use different dedicated output plugs (e.g., S-video). Because of the limitations in the number of video DACs (Digital to Analog Converters) in a DVD processor, many DVD players can output either in progressive scan mode or in interlaced scan mode but not both modes simultaneously. This is generally not a problem, except that if a user selects a mode (e.g., progressive scan) not supported by their monitor or television, and the television does not support it, the user may lose the video image output and can no longer see the GUI (Graphical User Interface) which would allow the user to switch back to the previous mode.

Similarly, if a consumer selects an output that the TV set is not connected to, the screen may go blank, and the consumer will see no image, and may believe that the DVD player or other consumer device is defective. This problem has led to a large number of warranty returns for consumer electronic devices in the past. This problem is costly for the manufacturer, as the units are not broken or defective, but merely set to operate in a mode that the user's monitor or TV does not support.

One solution to this problem is to provide extra hardware to output both progressive scan and interlaced scan modes at the same time through different outputs. The user can then switch between modes by plugging the television into different outputs. If one output does not work, the consumer can then plug it into another output. This solution is expensive to implement and adds to the number of plugs on the back of a DVD player.

Another solution is to add an extra “TV” button to the remote control in order to switch between different output modes even if the on-screen GUI is not visible. This approach has been implemented in some previous designs and will work, but it assumes that the consumer will read the manual and understand how the button works. If the consumer presses the button out of curiosity, inappropriate results may occur (output switches between modes when not desired). Moreover, putting an extra button on the remote control contributes to the crowding of buttons on the remote unit and also increases cost and complexity of the unit.

In addition to the aforementioned problems, with the advent of HDTV, further modes of operation may be possible, which may be incompatible with various television displays. Thus, the opportunity for a consumer to generate an output mode, which results in a blank screen or a garbled display increases. In the past, this situation has been serious. As noted above, it has led to warranty returns of consumer electronics products. A consumer may inadvertently switch to an unsupported mode, which results in a garbled or blank display. Since the consumer cannot now navigate the GUI menu system to return to the previous display mode, the consumer product is now useless.

WINDOWS™ software confronts a similar problem. A typical VGA controller may generate display images in any one of a number of resolutions and formats. However, not all VGA monitors and displays may support all formats and resolutions. Thus, when switching to a different resolution that is not supported by the monitor or display, a garbled image may appear on the display. The computer may display a message requesting whether or not the resolution change is successful. However, with a WINDOWS™ computer, rebooting in “safe” mode with 640×480 resolution and resetting the resolution if there is a problem are possible. Consumer products, such as DVD players, generally do not have such a reboot option.

### SUMMARY OF THE INVENTION

The present invention solves this problem for consumer electronics devices by providing a method whereby a new display mode or resolution is generated and a message displayed requesting the user to confirm whether the resultant display is acceptable. If the user does not respond to the message after a predetermined period of time (e.g., 20 seconds), the system reverts back to the previous resolution or mode.

The system thus prevents and corrects for the cases where a user selects an inappropriate video output. In addition, a user-friendly interface, which results in better customer satisfaction, is provided. Moreover, while some minor software changes to the operating system of the consumer electronic video device (e.g., DVD player) may be required, the need for new hardware may be eliminated.

### BRIEF DESCRIPTION OF THE DRAWINGS

FIG. 1 is a flowchart illustrating the operation of the apparatus of the present invention.

FIG. 2 is a simplified block diagram illustrating the basic components of the present invention.

### DETAILED DESCRIPTION OF THE INVENTION

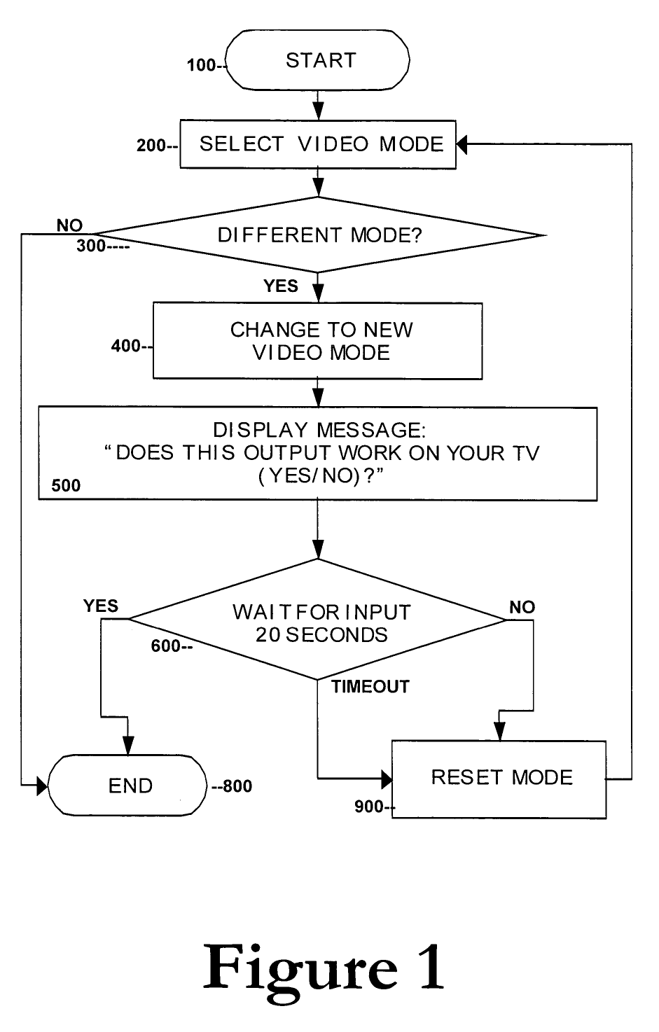

Referring to FIG. 1, a process is described for selecting different video output modes for a consumer device. This process may represent a subroutine on microprocessor software or firmware running on a consumer electronic device such as a DVD player or player/recorder, or the like. For purposes of illustration, the process begins at block 100 which may represent a branching from an overall program used to operate the consumer electronic device.

At block 200, a user selects a video mode, preferably from a menu displayed on a setup screen or option screen or the like, displayed on a television display connected to the consumer video device. The user selects a video mode from a menu containing a list of possible output modes by scrolling down the list and selecting one option using the OK or ENTER key on the remote control or on the control panel of the consumer electronic device. As noted above, examples of such different video modes may include, but are not limited to, progressive scan and interlaced modes.

At decision block 300, a determination is made as to whether the consumer has selected a different mode from the one presently being displayed. If the mode selected is the same as the present mode being displayed, no action may be taken and processing ends at block 800. Block 800 may represent a return to an overall control program or subroutine thereof.

If a different mode than the one being presently displayed is selected, processing passes from block 300 to block 400, where the consumer electronic device is switched to the new video mode selected by the consumer. At block 500, a message may be displayed on the screen on an overlaid block or window or the like with a message requesting input from the consumer as to whether the image is acceptable. An example of such a message may be “Does this output work on your TV (YES/NO)” as indicated in FIG. 1.

At block 600, the consumer may input a Yes or No response on the remote control device associated with or compatible with the consumer electronics device or optionally on the consumer electronics device itself. Alternately, other keys may be used to select whether the picture is acceptable, and these keys may be indicated on the displayed message.

If the consumer enters YES or other appropriate key input, the new mode is accepted and processing passes to block 800, which represents an end to the present subroutine. On the other hand, if the consumer enters NO or the system times out after a predetermined time period (e.g., 20 seconds), the system resets the output mode to the previous output mode and returns processing to block 200.

In this manner, the user can select any of a number of video output modes without fear of “locking up” the system or causing an unwanted response. In this manner, the system is made “idiot proof” which is the standard of operation necessary for most consumer grade appliances. If the consumer inadvertently selects a video mode incompatible with his television set, then the system will switch back to the previous mode after a predetermined period of time.

The present invention may also be used to inform consumers that certain modes are not supported by their television. If a consumer selects a particular output mode and does not respond to the query in step 500 within the time period of step 600, the system may display a message on the next attempt to enter that mode. Such a message may read, “It appears your television does not support this video mode, try anyway? (YES/NO)”. If the consumer selects “YES”, the process of FIG. 1 will be repeated accordingly.

In this manner the consumer will understand why his television is displaying a garbled image and thus not incur additional expense to the manufacturer with calls and complaints to customer service support lines. The consumer is still able to use these various modes, for example, if the consumer buys a new TV, which supports both interlaced and progressive scan modes.

Alternately, modes which are selected and then not verified in block 500 of FIG. 1 may be deleted, at least temporarily, from the available list of modes in block 200. Thus, the user is presented with a shortened list of available modes to select from, such that incompatible modes are deleted from the list to avoid confusion. A menu selection to “show all modes” may be provided to allow the user to select from “deleted” modes, and/or the system may be reset with a certain command key or procedure (e.g., hold “Enter” key while powering up) to re-enable the deleted modes.

Also, the apparatus, system, and method of the present invention may default to a fail-safe mode of operation if a selected mode does not display correctly. For example, at the block 600 of FIG. 1, if no input is received within the predetermined time period (e.g., 20 seconds), then the system may revert to standard analog NTSC interlaced video output, for example. Alternately, if the system is entered into a setup mode for a predetermined period of time, and not properly closed out, then the device may revert to such a fail-safe mode of operation on the assumption that the consumer cannot view the menus properly. The system may also be programmed to revert to such a fail safe mode if it is turned on and off a certain number of times in rapid succession (e.g., five), thus reverting to its preprogrammed factory settings if a consumer becomes frustrated with the apparatus.

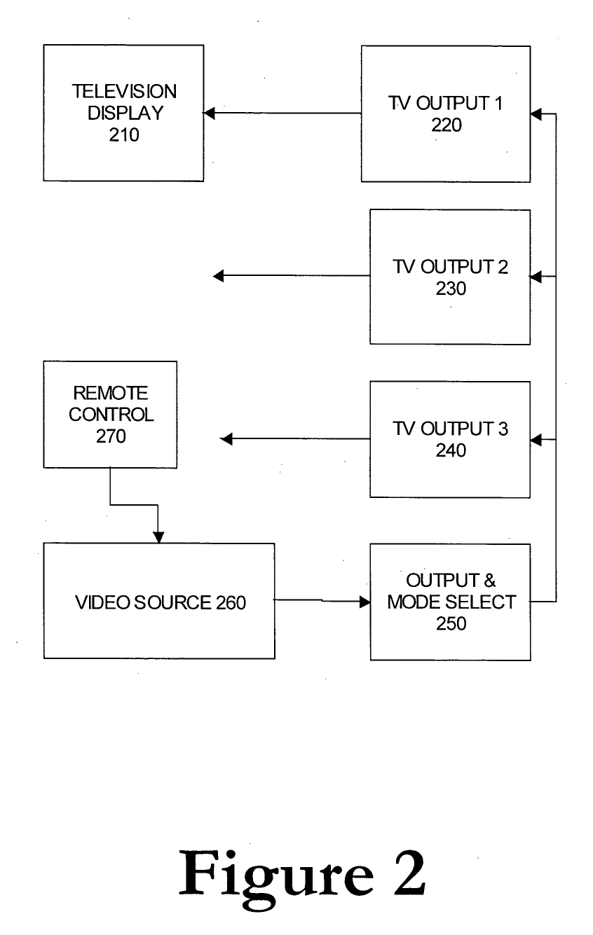

FIG. 2 is a simplified block diagram illustrating the basic components of the present invention. In the diagram of FIG. 2, television display 210 may comprise an NTSC analog television, a PAL or SECAM television, television monitor, HDTV or other type of television display having one or more display modes of operation. Television display 210 is generally a consumer-provided device and thus does not form part of the invention per se.

The remainder of the components in FIG. 2 may be embodied in a consumer device, such as a DVD player or recorder/player, in accordance with the present invention. A video source 260 provides a source of video data. This source may comprise a DVD disc, a hard drive, or other data storage source or data stream source (e.g., streaming video data, cable or satellite TV signal, off-the-air TV signal, or the like). The video source may output the video data in one or more formats depending upon the nature of the source.

In order to provide compatibility for the increasing number of television signal types, one or more of television outputs 220, 230, and 240 may be provided in the apparatus to provide different types of output signals to television display 210. Alternately, a single output maybe provided with programmable features allowing the output format to be suitably changed. In the example of FIG. 2, television display 210 is shown connected to a first television output 220, while the other outputs are not connected.

Output and mode select 250 may determine which outputs actively generate a video output signal. In one embodiment, all outputs 220, 230, and 240 generate output signals continuously in different output modes (e.g., composite, S-video, component video, analog NTSC, or the like). The consumer may then connect television display 210 to a corresponding output 220, 230, 240 which is compatible with television display 210.

Output and mode select 250 may also control one or more of television outputs 220, 230, and 240 to control the output mode of operation, for example, interlaced or progressive scan modes. Other output modes may also be selected for different television outputs 220, 230, and 240. For example, a television output (e.g., TV output 1, 220) may selectively generate NTSC video, PAL video, or SECAM video, under control of output and mode select 250. Similarly, another output (e.g., TV output 2, 230) may be programmed to output composite or component video selectively, in order to reduce the number of output plugs on the back of a consumer device such as a DVD player.

The consumer may input commands via remote control 270 to video source 260, the latter of which incorporates a microprocessor control which may control output mode and select 250. In response to consumer inputs via remote control 270, the output mode may be selected, as set forth in the process steps of FIG. 1, and the necessary menu and messages displayed on television display 210. If an output mode selected does not display on television display 210, either due to an incompatibility of output modes or due to the television being connected to the wrong output 220, 230, 240, the system will time out if a response is not received from the consumer, and the previous mode or a default mode reinstated.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A method for providing multiple display modes in a consumer product with a television display output, the method comprising:
switching a display mode of a consumer product to a selected display mode by a consumer among available display modes;
displaying, for a predetermined period of time, a message requesting input from the consumer as to whether the selected display mode is satisfactory;
maintaining the selected display mode in response to an input received from a consumer indicating the selected display mode is satisfactory; and
reverting back to a previous display mode in response to an input received from the consumer indicating the selected display mode is not satisfactory or in response to no response being received from the consumer within a predetermined time period.

2. The method of claim 1, wherein receiving from the consumer, a selection of one of the available display modes further comprises:
displaying a plurality of available display modes; and
receiving from the consumer, a selection of one of the available display modes.

3. The method of claim 1, further comprising:
removing the selected display mode from being among the available display modes for the television display output in response to an input being received from the consumer indicating the selected display mode is not satisfactory or in response to no response being received from the consumer within the predetermined time period.

4. The method of claim 1, further comprising:
flagging the selected display mode from being among the available display modes in response to an input being received from the consumer indicating the selected display mode is not satisfactory or if no response is received from the consumer within the predetermined time period such that if the selected display mode is again selected, a message is displayed to the consumer indicating that the selected display mode has previously been rejected by the consumer.

5. The method of claim 1, wherein the plurality of available display modes includes interlaced and progressive scan modes.

6. The method of claim 5, wherein the plurality of available display modes further includes NTSC analog video mode, PAL mode, and SECAM mode.

7. The method of claim 5, wherein the plurality of available display modes further includes composite video mode, S-video mode, and component video mode.

8. The method of claim 1, wherein the plurality of available display modes includes NTSC analog video mode, PAL mode, and SECAM mode.

9. The method of claim 1, wherein the plurality of available display modes includes Composite video mode, S-video mode, and component video mode.

10. The method of claim 1, wherein the plurality of available display modes includes NTSC analog video mode and HDTV mode.

11. The method of claim 1, wherein reverting back to a previous display mode comprises reverting to a default display mode.

12. The method of claim 11, wherein the default display mode is NTSC analog video mode.

13. An apparatus for providing multiple display modes in a consumer product with a television display output comprising:
a display controller for displaying a plurality of available display modes on the television display;
an input selection system for receiving from a consumer, a selected display mode among the available display modes;
an output selection system for switching a display mode of the consumer product to the selected display mode;
wherein the display controller displays, for a predetermined period of time, a message requesting input from the consumer as to whether the selected display mode is satisfactory, maintaining the selected display mode in response to an input received from the consumer indicating the selected display mode is satisfactory, and reverting back to a previous display mode in response to an input received from the consumer indicating the selected display mode is not satisfactory or in response to no response being received from the consumer within the predetermined time period.

14. The apparatus of claim 13, wherein the display controller removes the selected display mode in response to an input received from the consumer indicating the selected display mode is not satisfactory or in response to no response being received from the consumer within the predetermined time period.

15. The apparatus of claim 13, wherein the display controller flags the selected display mode from being among the available display modes in response to an input received from the consumer indicating the selected display mode is not satisfactory or in response to no response being received from the consumer within the predetermined time period such that if the selected display mode is again selected, then a message is displayed to the consumer indicating that the selected display mode has previously been rejected by the consumer.

16. The apparatus of claim 13, wherein the plurality of available display modes includes interlaced and progressive scan modes.

17. The apparatus of claim 16, wherein the plurality of available display modes further includes NTSC analog video mode, PAL mode, and SECAM mode.

18. The apparatus of claim 16, wherein the plurality of available display modes further includes composite video mode, S-video mode, and component video mode.

19. The apparatus of claim 13, wherein the plurality of available display modes includes NTSC analog video mode, PAL mode, and SECAM mode.

20. The apparatus of claim 13, wherein the plurality of available display modes includes Composite video mode, S-video mode, and component video mode.

21. The apparatus of claim 13, wherein the plurality of available display modes includes NTSC analog video mode and HDTV mode.

22. The apparatus of claim 13, wherein the display controller reverts to a default display mode if a response is not received from the consumer within the predetermined time period.

23. The apparatus of claim 22, wherein the default display mode is NTSC analog video.
